(19) United States
(12) Patent Application Publication
(10) Pub. No.: US 2013/0288919 A1
(43) Pub. Date: Oct. 31, 2013

(54) LABEL-FREE MOLECULE DETECTION AND MEASUREMENT

(71) Applicant: IMPERIAL INNOVATIONS LIMITED, London (GB)

(72) Inventor: Mino Green, London (GB)

(21) Appl. No.: 13/924,503

(22) Filed: Jun. 21, 2013

Related U.S. Application Data
(62) Division of application No. 12/863,900, filed on Jul. 21, 2010, now abandoned.

(30) Foreign Application Priority Data
Jan. 22, 2008 (GB) 0801142.1

(51) Int. Cl. G01N 27/48

(52) U.S. Cl. CPC G01N 27/48
USPC 506/9; 204/403.01; 506/13; 506/32

(57) ABSTRACT

A system and method for electrically detecting a target material in a sample without the need for labeling is described. A probe supporting member defining at least one hole is functionalized with target specific probe material and a change in the hole area on binding of target material is detected as a change in an ionic current through the hole. In some embodiments, an electro-chemical cell comprising an electrode having a conducting layer and a porous insulating layer is provided. In some embodiments, an electrically addressable array is provided for detection of a potentially large number of target materials in a sample.

This divisional patent application claims priority to and the benefit of U.S. patent application Ser. No. 12/863,900 (371(c) filing date Jul. 21, 2010, international filing date Jan. 21, 2009), which is a U.S. national phase application of PCT Application No. PCT/GB2009/000161 filed Jan. 21, 2009, which claims the priority of Great Britain patent application number GB 0801142.1 filed Jan. 22, 2008, which are all incorporated herein by reference in their entirety.

The present invention relates the detection of targets and, in particular although not exclusively, to the label-free detection of proteins and other target molecules.

A conventional approach to detecting certain target molecules, for example a specific protein, is to functionalize a support surface with probe molecules, for example antibodies specific to the protein in question. A sample to be tested for the presence of the specific protein is applied to the surface, which is then washed to remove any of the sample which has not bonded to the probe molecule attached to the surface. Any of the specific target molecules which have bonded to the probe will remain on the surface and are detected using, for example, fluorescent labels or makers which have previously been attached to the protein in question. Significantly, this conventional technique requires a label of some kind to be attached to the protein in question such that its presence can be detected.

The importance of label-free protein detection has been recognized in the biological sciences because of its importance for medical and biological applications, not least because it dispenses with the need to label target protein.

In recent years a number of techniques have been proposed and investigated, such as functionalized silicon nano-wires or carbon nano-tubes. Currently commercial implementations utilize methods such as micro-arrays and surface plasmon resonance.

Among the nano-structure based techniques, many require expensive equipment or expensive fabrication techniques, e.g. electron beam lithography, or methods currently inefficient for mass production such as harvesting and individual positioning of randomly grown nano-wires to form transistor structures. Therefore, there exists a need for an inexpensive detection scheme that can be widely used for a range of chemicals and molecules such as proteins, DNA, RNA and small viral particles or bacteria.

In a first aspect of the invention there is provided an electrode structure for use in detecting a target binding to a probe immobilized on the electrode structure, as claimed in claim 1. In some embodiments, the structure includes an electrode layer secured to a perforated insulating layer supporting probe molecules lining the inside of the perforations in the insulating layer. Advantageously, the probe is disposed on the insulating layer in relation to a hole in the insulating layer such that the effective cross-section of the hole (and hence the effective exposed electrode area) changes on binding of a target to the probe. This allows the binding to be detected by the corresponding change in the cross-section of the hole, which can be detected by a change in a current flowing in an electrolyte through the hole. Further, this arrangement provides a compact and efficient configuration which is easy to manufacture.

Advantageously, the probe may include probe molecules, such as an antibody, single stranded DNA or single stranded RNA and the probe may be supported by the member on the surface within the hole. The probe may be any chemical or material specifically binding to a respective target chemical or material to be detected.

The holes may have a diameter in the range of 100 to 2000 nm, for example 300 nm and may have a depth in the range of 5 nm to 500 nm, for example 50 nm. The holes may cover a fractional area of the member in the range of about 0.05 to about 0.6, for example 0.2. The holes may, for example, be nano holes or pores (having a diameter of about 100 nm or less), sub-micron holes or pores (having a diameter between about 100 nm and about one micrometer) or micro pores or holes having a diameter of the order of micrometers.

For example, the porous insulating layer may comprise SiO₂. The electrode layer may comprise platinum. Adhesion between the platinum and SiO₂ layer may be improved by a Cr layer disposed between the two respective layers. The electrode layer may, at its other face, be secured to an insulator. Advantageously, this helps to prevent or reduce a leakage current passing other than through the probe supporting member. Other means for ensuring that the current between the electrodes passes through the probe supporting members may of course be equally employed.

Advantageously, the probe may include a probe molecule secured to the probe supporting member by a pH dependent bond. This allows the electrode layer to be used to locally change the pH in the region of the probe supporting member, allowing the bond of the probe with the probe supporting member to be broken to re-functionalize the probe supporting member with probe molecules.

In a second aspect of the invention, there is provided a system for detecting a target binding to a probe as disclosed herein and claimed.

The measured quantity may be representative of a projected area of the pore or pores projected onto an electrode or conducting layer. The system is arranged with circuitry for cyclic voltammetry and has a processor arranged to detect a change in, for example, peak current of the cyclic voltammetry as representative of targeted probe binding. Advantageously, the processor may further be arranged to estimate an effective size of a target as a function of the change in peak current, taking account of the average hole diameter of the probe supporting member in this estimation.

In a third aspect of the invention, there is provided a method of detecting the binding of a target to a probe molecule as disclosed herein and claimed.

In a fourth aspect of the invention, there is provided an electrically addressable array as disclosed herein and claimed.

In a fifth aspect of the invention, there is provided a system and method of reading an addressable array as disclosed herein and claimed.

Embodiments of the invention are now described, by way of example only, with reference to the accompanying drawings, in which:

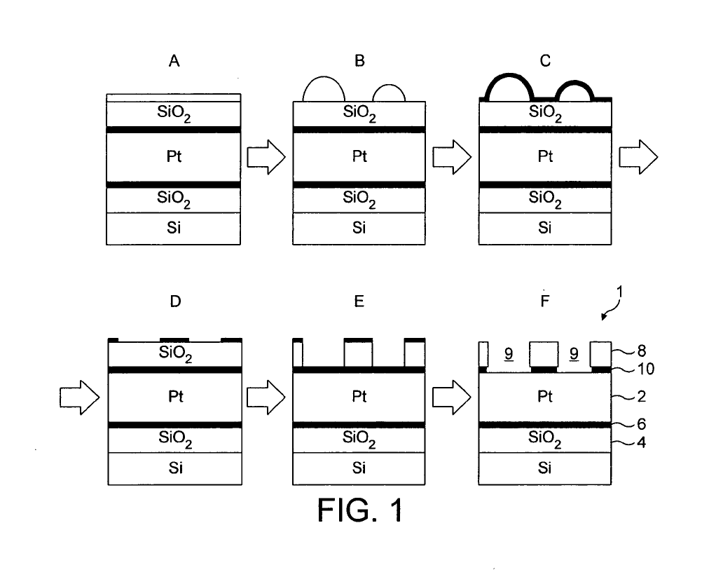

FIG. 1 illustrates a method of manufacturing an electrode structure including a porous probe supporting member;

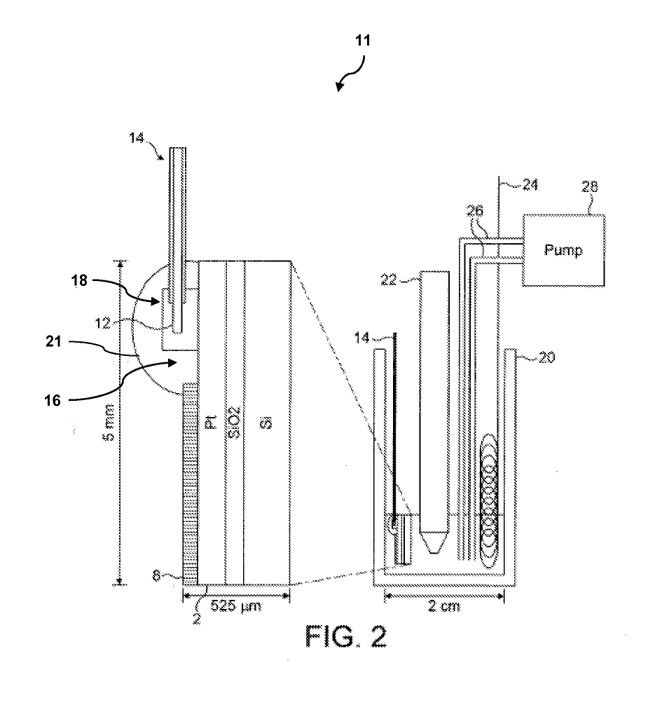

FIG. 2 illustrates an electrochemical cell having an electrode including such an electrode structure according to some embodiments;

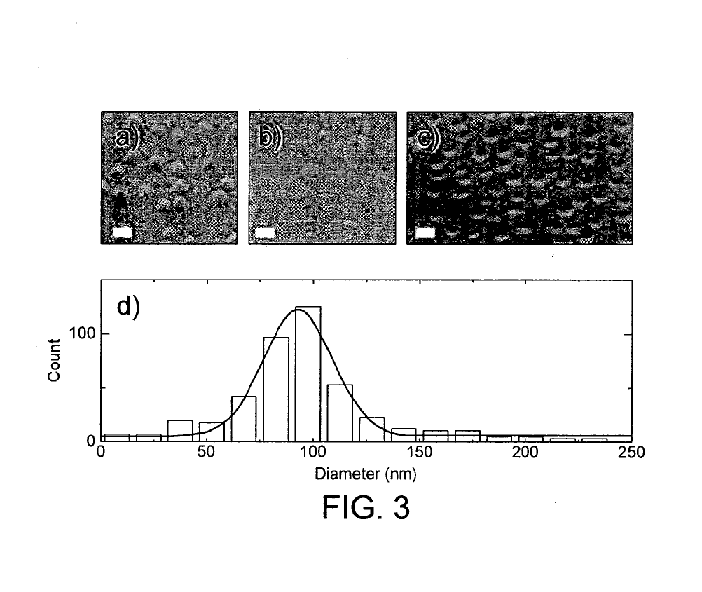

FIG. 3 shows microelectrographs of a porous surface of a probe supporting member and a corresponding distribution of pore diameters;

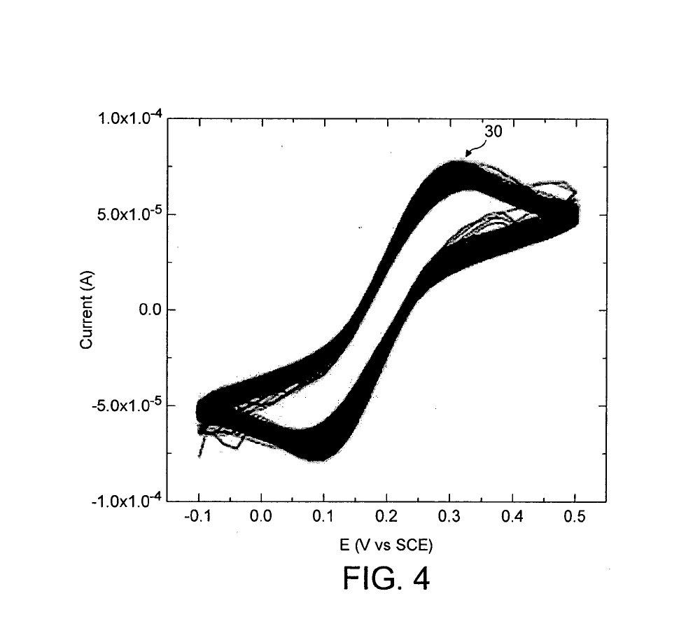

FIG. 4 shows exemplary cyclic voltammetry traces for an un-functionalized electrode assembly;

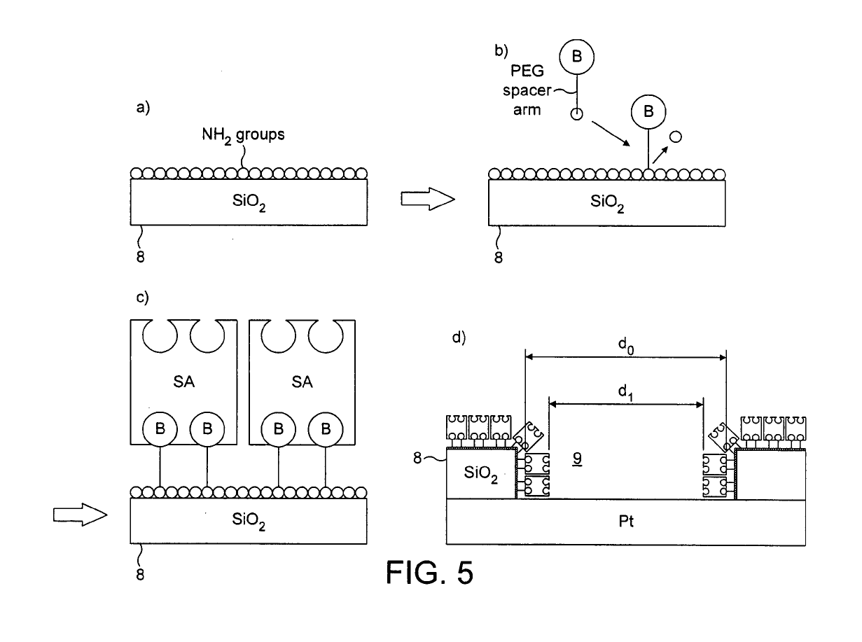

FIG. 5 illustrates a functionalization process;

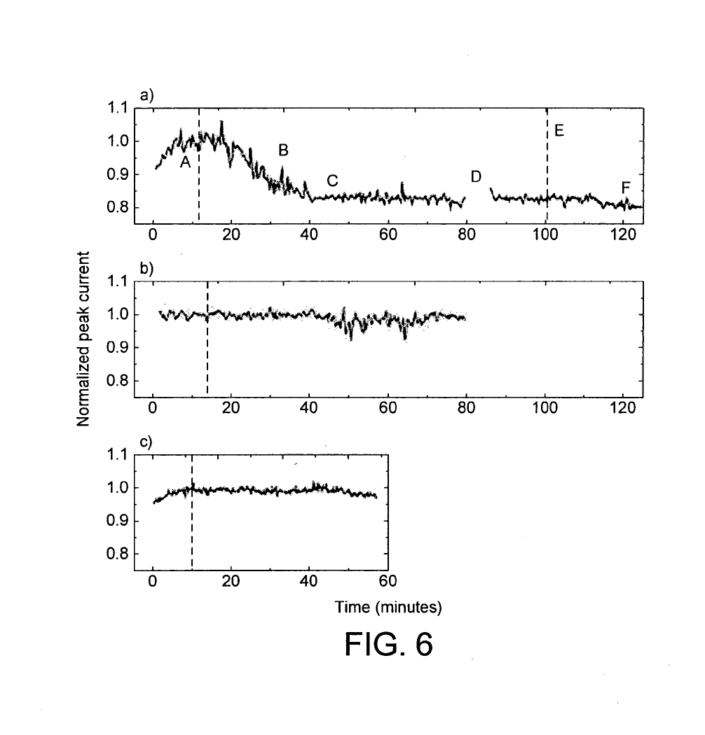

FIG. 6 depicts peak current traces for a functionalized electrode assembly and controls;

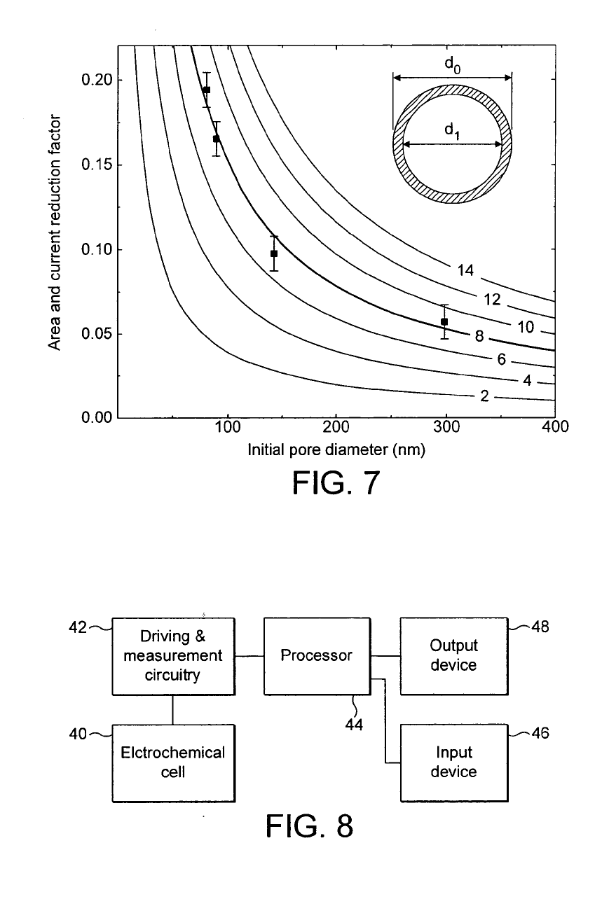

FIG. 7 illustrates target size estimation and corresponding experimental data;

FIG. 8 depicts a system for detection and size-estimation of targets.

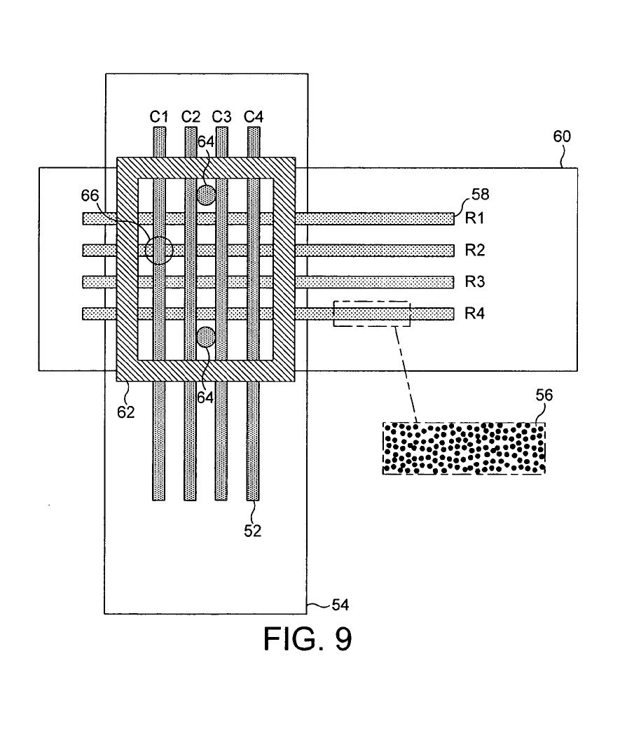

FIG. 9 depicts an addressable electrode array according to some embodiments;

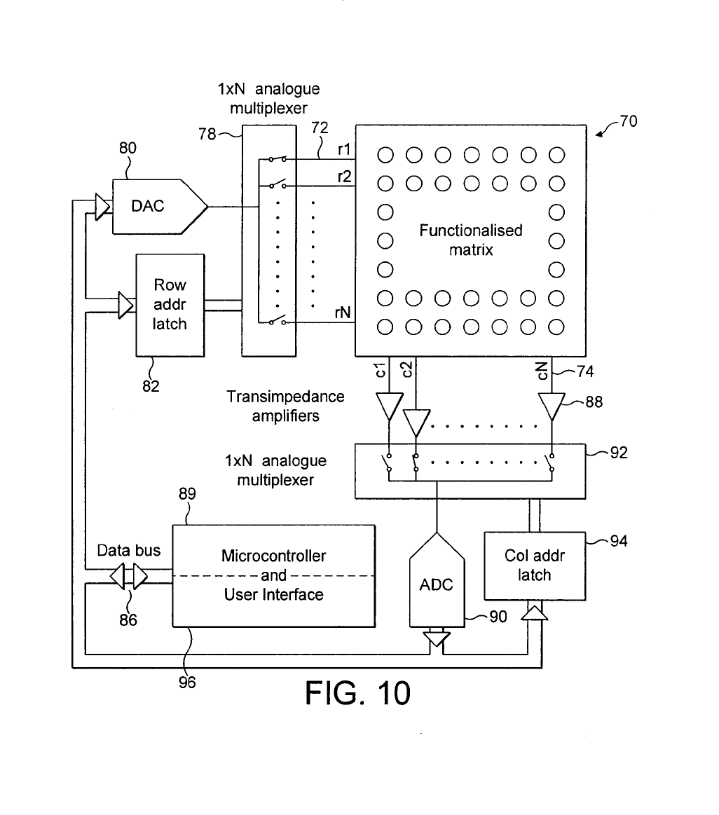

FIG. 10 depicts a readout circuit for the array of FIG. 9; and

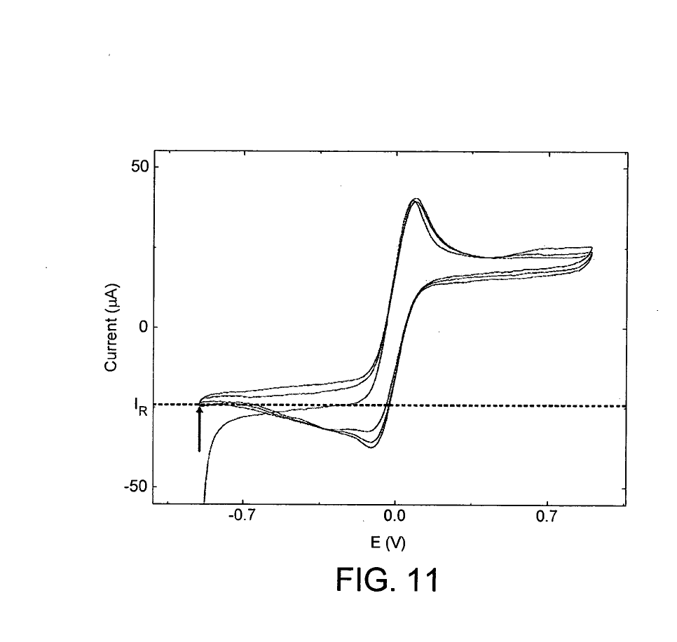

FIG. 11 depicts voltammograms illustrating a measurement technique.

In overview, an electrical detection technique for label-free detection of proteins or other molecules, such as listed above, is described which may also be used for simultaneous estimation of a major size parameter of the protein in its natural medium, in effect, a caliper for bio molecules. In some embodiments, the fabrication lithography is based on a type of patterning using naturally developed CsCl nano-islands as the resist as described in detail below; a technique which can offer cost-effective nano-pattering of large areas.

Some embodiments include an electrochemical cell having two platinum electrodes in an aqueous electrolyte, one of the electrodes being a planar structure of platinum on silicon, the other platinum electrode being covered with insulating silicon dioxide perforated by pores or holes that have been etched down to the platinum. A wire electrode may be used instead of the planar (unperforated) electrode. Other suitable metals can be used for the electrodes, for example gold.

Any ionic current to the other electrode must pass through the pores, which may expose typically a quarter of the electrode surface area. The pores are functionalized (with “probe” molecules such as antibodies) to bind a particular, “target”molecule (for example a protein). If the pores are made small enough (for example 10-100 times the “diameter” or largest size scale of the protein to be detected), the attachment of the protein to the functionalized pore side-walls leads to a measurable reduction in the exposed platinum electrode area at the bottom of the pore, and hence to a decrease in electrode current providing a signal indicating the presence of the protein. The electrode current is measured using a fast, chemically inert, redox couple (and depends on the IN characteristics of the redox couple); and since the fractional active area of exposed platinum is relatively large (for example ¼) the electrode current-voltage relation is believed to be as for a planar electrode and proportional to the exposed electrode area. The electrode voltage is measured with respect to a reference electrode, for example a saturated calomel electrode. The resulting (electrically measured) decrease in pore diameter associated with the binding of the target is indicative of the presence of the target in the sample may give useful information on the attached target molecule size.

Fabrication of Electrode Assembly

Using self-organized CsCl islands as a means for nano-lithography (see for example: Mino Green, M. Garcia-Parajo, F. Khaleque and R Murray “Quantum pillar structures fabricated on n+ gallium arsenide fabricated using “natural” lithography”, Appl. Phys Lett. 63,264-266 (1993); Mino Green and Shin Tsuchiya, “Mesoscopic Hemisphere Arrays for use as Resist in Solid State Structure Fabrication.” J. Vac. Sci. & Tech. B, 17, 2074-2083 (1999); Shin Tsuchiya, Mino Green and RRA Syms, “Structural Fabrication Using Cesium Chloride Island Arrays as Resist in a Fluorocarbon Reactive Ion Etching Plasma”, Electrochemical and Solid-State Letters, 3, 44-46 (2000), all herewith incorporated herein by reference), a process, in accordance with some embodiments, is now described for the fabrication of platinum (Pt) electrodes covered with a layer of silicon dioxide perforated through to the Pt by pores or holes.

The process is now described with reference to FIG. 1 schematically depicting the electrode structure 1 resulting from the process steps described below carried out on substrate areas of, for example, about 5 cm×5 cm. The starting point A of the process is a silicon substrate (for example 525 microns thick, (100) orientation, boron doped in the range 1-10 Ωcm which is covered with 200 nm of thermally grown silicon dioxide, followed by sputtered layers of Cr (10 nm), Pt (150 nm), Cr (10 nm) and finally SiO₂ (40 nm). The chromium films are thought to serve as adhesion layers aiding adhesion between the Pt and SiO₂ layers. Onto this film stack, a 4 nm layer of CsCl is evaporated. Upon exposure to humid air at step B, the CsCl layer re-organises to nano sized CsCl hemispheres (or “islands”). A humidity range up to near 70%, exposure for 1 h, is used to obtain hemispheres in the range of 100-300 nm. A brief exposure (for example 10 s) to 100% (dew-forming) humidity is used in some embodiments to create micron-sized hemispheres, for example for use in fluorescence microscopy investigations. At step C, a layer of Cr (6 nm) is evaporated on top of the CsCl hemispheres. This is followed by a lift-off step D, performed by immersing the structure in water for 10 minutes in an ultrasonic tank to remove the Cr covering the hemispheres and allow the CsCl to dissolve. The resulting perforated Cr structure is then utilized as an etch mask for an etching step E to pattern the underlying SiO₂ layer by reactive ion etching (4 minutes at 25 cm²/s CHF₃, 25 cm²/s Ar, 5 cm²/s O₂, 200 W RF power, 50 mTorr base pressure). A final chemical etching step F (Rockwood Cr etch, 22% wt. ceric ammonium nitrate, 5% wt. acetic acid in H₂O, 20 s etch time) is used to simultaneously remove the exposed Cr adhesion layers to expose the Pt electrode at the bottom of the pores, as well as the remaining resist on the uppermost SiO₂ layer.

The resulting electrode structure 1 includes a Pt layer 2 secured to a SiO₂/Si substrate 4 by a Cr adhesion layer 6. The Pt layer 2 is in turn covered by a perforated SiO₂ layer 8 supported on a Cr adhesion layer 10 and defining pores 9 therein where the CsCl islands were.

FIG. 3a-c, show scanning electron microscopy pictures of example CsCl hemispheres, and the resulting pore structure. Three different humidities (with 1 hour exposure) were used to create exemplary chips with distributions of three different mean diameter pores. The different mean diameters were calculated from the electron micrographs, as 93 nm, 155 nm and 310 nm, for relative humidities of 44%, 55% and 70%, respectively. The fractional pore coverage (i.e. the fractional coverage or packing density of the islands) was in the range of 15-25% for the different chips. FIG. 3d shows the diameter distribution for the smallest pore ensemble, with a Gaussian distribution fitted (solid line in FIG. 3).

To prepare an electrode assembly or chip 11 for electrochemical experiments, the electrode structure 1 is cleaved into smaller chips (˜7 mm×7 mm size) and provided with connector wires, as is now described with reference to FIG. 2. The perforated SiO₂ layer 8 is removed mechanically over a small area of the chip exposing a portion 16 of the Pt layer 2. The exposed end 12 of a plastic coated Cu wire 14 is fixed onto the exposed portion 16 of the Pt layer 2 using a droplet 18 of silver loaded paint and, after drying, the resulting junction is sealed using quick setting epoxy glue 21 (RS Ltd.) such that all metallic junctions were sealed so that only the Pt layer 2 is exposed to electrolyte through the perforated SiO₂ layer 8 when the electrode assembly 11 is used.

Electrode Operation

With a view to ensuring reproducibility of electrochemical cyclic voltammetry (cv.) the Fe(CN)₆^{3+/4+} redox couple, which is fast enough for the Nernst potential to hold over a substantial voltage range, is used in some embodiments to operate the electrode assembly 11 (For further details on cyclic voltammetry, see e.g. C. H. Hamann, A Hamnett, W. Vielstich, “Electrochemistry”, Wiley-VCH, Weinheim/New York, 1998 pp 222-249, herewith incorporated by reference herein). This redox couple is known to give stable measurements, and is made-up, in some embodiments, in phosphate-buffered saline solution (hereby denoted PBS; an exemplary composition is 8 g/l sodium chloride 0.2 g/l potassium phosphate monobasic, 1.15 g/l sodium phosphate dibasic and 0.2 g/l potassium chloride, resulting in a buffer pH of 7.4) giving 10 mM concentrations of potassium ferricyanide/potassium ferrocyanide (K₃[Fe(CN)₆]/K₄ [Fe(CN)₆].3H₂O). It is understood that the electrode material may be selected such that the chosen redox reaction is fast, for example platinum or gold is chosen in some embodiments.

FIG. 2 shows an electrochemical cell setup according to some embodiments including a glass cell 20 containing electrolyte solution and the electrode assembly 11, a calomel reference electrode 22, and a coiled platinum wire (1 cm coil length, 0.7 mm wire diameter) counter electrode 24. The reference electrode 22 ensures a voltage scale which is universal. However, since the quantity of interest (see below) is a relative measurement, the reference electrode can be omitted in some embodiments.

To achieve a small, but reproducible, amount of stirring of the electrolyte solution, two 3 mm diameter silicone tubes 26 connected to a peristaltic pump 28 are immersed in the solution. The amount of stirring is selected to give reproducible conditions for the cv curves. For example, a suitable flow rate for the stirring is 2 ml/min in some embodiments and the total electrolyte volume, including the electrolyte in the pump and tubing, is 6 ml.

A computer controlled PG580 potentiostat/galvanostat connected to the electrodes is used to perform the cv. measurements. A scan (scan rate, 0.1 V/sec; voltage range −0.1 to 0.5V vs. a standard calomel electrode. 400 cycles were acquired with 12 s cycle time for a total time of 80 minutes) of an unfunctionalized electrode assembly 11 (mean pore diameter 93 nm) is shown in FIG. 4: the current maximum 30 of the oxidation scan is used as measure of the exposed Pt area.

Electrode Functionalization

In what follows, electrode functionalization in accordance with some embodiments is described with reference to the biotin-streptavidin interaction as a model target/probe system, using biotin (B) with a chain and linker (NHS-PEG12-biotin, from Perbio Biotech UK Ltd.) for attachment to a chemically activated SiO₂ surface. PEG is a 12 unit polyethylene glycol chain (5.6 nm in length) attached to an N-hydroxysuccinimide (NHS) linker molecule. Functionalization of the electrode assembly 11 is now described with reference to FIG. 5. The SiO₂ layer 8 of the electrode assembly 11 is first modified using 3-aminopropyltriethoxysilane (APTES), FIG. 5a, which bonds to silicon dioxide and forms an amide bond with the PEG-biotin chain, eliminating the NHS molecule, FIG. 5b, to create a biotinylated surface on the SiO₂ layer 8. The polyethylene glycol acts as a spacer arm and may help to prevent steric hindrance of the streptavidin binding, since streptavidin (SA) has binding pockets of substantial depth into which the biotin binds, FIG. 5c.

It has been established that surface biotin saturation occurs when there is roughly 60 times more biotin in the solution than that required to make a monolayer in order to obtain a suitable near optimum sub-monolayer coverage (see Mino Green, Feng-Ming Liu, Lesley Cohen, Peter Köllensperger and Tony Cass, “SERS Platforms for High Density DNA Arrays”, Faraday Discussions, 132, 269-280 (2005), herewith incorporated by reference herein). On the present patterned electrode chip, biotin (and later streptavidin) binds both to the outer SiO₂ surface and also to the inside of the pores 9. If the pores 9 are of sufficiently small diameter, the attachment of the streptavidin should cause an appreciable change in pore diameter, illustrated in FIG. 5d.

Every probe/target system has a corresponding desired probe fractional coverage at which, when fully interacted with target molecules, a mono-layer of probe—target molecules is achieved. The desired molecular density (number of molecules per square centimetre) of probe molecules will thus vary, for example it is 4×10¹³/sq.cm for single strand DNA probes and 2×10¹³/sq. cm for biotin probe to target streptavidin target. As the size of the target molecule increases so the desired surface density of probe molecules decreases.

To functionalize the electrode chip it is cleaned using an oxygen plasma (O₂ flow 60 cm2/s, 200 W, 50 mTorr base pressure, 20 s duration). The chip is then modified by immersing it in a 2% solution of APTES in dry acetone for one minute at room temperature. The modified chip is then rinsed, first in acetone and then in PBS solution. The chip is stored in PBS solution until biotin/chain functionalization. Just prior to use, the dry probe molecule material is made up in PBS solution to 5 μM and applied, for example in droplets, onto the front face (SiO₂ layer 8, exposed Pt layer 2) of the nano-chip (20 μl quantity for a 7 mm×7 mm size chip). A suitable range of concentrations for biotin is 2 to 5 μM. During functionalization (for example for 1.5 h) the chips are kept at room temperature in a closed container in a humid atmosphere (to prevent or reduce evaporation). After the biotin functionalization each chip is rinsed three times in 2 ml PBS solution in which it is then stored.

A fluorescence microscopy study of chips with micron-sized pores indicates that unfunctionalized chips do not bind streptavidin to a significant extent if the concentration is maintained at a low enough level, for example 33 nM, and further that the platinum electrode surface at the bottom of the biotin-functionalized pores 9 binds streptavidin to a significantly lower extent than the silicon dioxide surface 8 of the chip.

It will be understood that the functionalization protocol, parameters and chemicals used will depend on the specific probe molecule or molecules used and known protocols can be used or new ones established using trial and error. One such parameter is the probe molecule concentration required for a given surface coverage of the functionalization surface.

In some embodiments, the chip could be functionalized with a compound of molecules such as biotin bonded to the treated SiO₂ surface 8, streptavidin bonded to the biotin and a biotinylated antibody or other probe bonded to the streptavidin. Advantageously, this allows the chip to be re-functionalized by breaking the streptavidin bond using a local, pH change electrochemically induced by the chip electrode itself, washing and then applying a different streptavidin/probe combination. Other probe/target systems are described in P. Cutler. Proteomics, vol 3, 2003, 2-18 or Zhu et al, Current Opinion in Chemical Biology, vol 5, 2001, 40-45, both incorporated herewith by reference.

Yet a further probe molecule could be single stranded DNA molecules. On hybridization with its complementary molecule, the resulting double-stranded DNA curls up into a double-helix, thereby increasing, rather than decreasing the pore diameter on probe to target binding.

Detection of Probe—Target Binding

In one specific example for the detection of SA binding, biotin-functionalized electrode assemblies or chips 11 are immersed in the ferri-ferrocyanide PBS electrolyte. The cv. measurement, with circulation of the electrolyte as described above, is started and allowed to run for 10-15 minutes. This stabilization treatment may be advantageous in order to remove probe molecules weakly attached to the exposed surface of the Pt layer 2. Then, for example, 10 μl of 330 nM streptavidin solution is added to the electrolyte yielding a target molecule concentration of 0.55 nM To minimize the disturbance due to target molecule insertion the same ferro-ferricyanide-/PBS composition is maintained during addition. The cv. measurement is then run (for example for as much as two hours or much less). Cv. scan intervals can be set −0.1 to 0.5 V (vs SCE) at a scan rate of 0.1 V/s. It will be understood that these protocols will be readily adapted as appropriate for the probe/target systems in question.

For data analysis the maximum oxidisation current values 30 (illustrated in FIG. 4) of the oxidation peaks are extracted from the cv. data and taken as a measure of the exposed surface of the Pt layer 2 within the pores 9. Small drifts of the maximum current value can optionally be compensated by linear background subtraction from the data in some embodiments. Since the signal of interest relates to the area change of the nano-pores 9 due to the binding of the streptavidin (or other target molecule) to the inside of the nano-pore walls, only the relative change in current rather than its absolute value is of primary interest.

FIG. 6 shows the normalized maximum oxidisation current, with the average current during the first stable interval taken as unity, as function of time for a number of different cases: (a) shows the response for a functionalized nano-electrode of 93 nm mean diameter, (b) shows the response of an non-functionalized nano-electrode also of 93 nm diameter, and (c) shows the response from a planar platinum electrode which underwent the same functionalization procedure as the nano-patterned electrode chip.

After initial stabilization (indicated by A in FIG. 6), 10 μl A of streptavidin solution (330 nM concentration) is added for an example measurement to the electrolyte (indicated by dashed lines) resulting in a 0.55 nM streptavidin concentration in the electrolyte. As can be seen from FIG. 6a, the functionalized nano-electrode chip shows a significant response (B), which is fully developed (C) after ˜30 minutes after the addition of the streptavidin. A significant reduction in the normalized maximum current of 17.4% was observed. After 80 minutes, the voltammetry measurement was briefly stopped and then restarted (D) in FIG. 6a. A second addition of 10 μl of streptavidin solution E (resulting in 1.1 nM streptavidin concentration in the electrolyte) shows that the chip is now saturated, as the current was only further reduced by 1-2% (F). By systematically varying the SA concentration from 5.5×10⁻¹¹ M to 1.1×10⁻¹⁹ M it has been found that the normalized response (relative drop in current) follows well a Langmuir type isotherm for the amount of SA adsorbed with a fitted dissociation constant in line with known values for surface-attached biotin/SA. For the unfunctionalized nano-electrode chip (FIG. 6b), no systematic response to the addition of SA is observed. An even weaker response was obtained from the planar platinum electrode (FIG. 6c), even though it underwent functionalization. The biotin-functionalized chips (both nano-electrode and plain) show an initial instability during the first 15 minutes which is not present when the experiment is restarted with the same chip (E) in FIG. 6a. This suggests that the initial instability is due to initial desorption of biotin-chains loosely bond to the Pt surfaces. Therefore, an initial period of cv to initialize or run in the chip is beneficial in some embodiments.

Size-estimation

The response to SA from functionalized chips with three different mean nano-pore diameters can be investigated to demonstrate size-estimation.

The chips have distribution of nano-pore diameters but it can be shown that upon the attachment of a thin layer on the nano-pore wall, the reduction in total area of the ensemble of nano-pores having a size-distribution is very similar to the area reduction of an ensemble of pores all being of the mean diameter (in effect the larger response from the smaller pores is cancelled by the smaller response of the larger pores). Since the area reduction of the pores on a chip when the streptavidin binds to the inside of the pore walls should cause a proportional reduction to the cv. peak current of the chip the relative reduction in current for the three different functionalized chips when streptavidin solution is added to the electrolyte can be compared to the calculated area reduction for nano-pores of different size when a thin layer is added to the inside of the pore wall.

FIG. 7 shows the predicted resulting relative area reduction (d₀−d₁)²/d₀ of the nano-pores of different initial diameter after functionalisation d₀ being reduced in diameter to d₁ (as shown in the inset) plotted versus the initial diameter after functionalization, d₀, for different reductions in diameter (2-14 nm), together with the observed relative reduction in cv. oxidisation peak current for chips with nano-pores of different diameter.

For the analysis of experimental data, the initial pore diameter is taken as the mean diameter extracted from the SEM images of the fabricated chips, minus twice the chain length of the biotin spacer arm (2×5.6 nm) As can be seen from FIG. 7, the experimental data corresponds to the relative area reduction of “ideal” pores, if the diameter reduction is taken as 8 nm, thus corresponding to an added layer of 4 nm thickness on the inside of the pore wall. The geometrical size of a streptavidin molecule is between 4.8 nm and 5.8 nm (depending on the axis), which is slightly larger than observed. However, considering that biotin binds to streptavidin in a pocket embedded in the streptavidin molecule (schematically shown in FIG. 5c) the obtained predicted 4 nm addition is very reasonable.

It is possible that streptavidin may not form a complete monolayer and thus only partially block the ion flow through the pore close to the nano-pore walls. However, even if the layer is not complete, an ion flowing down into the pore will be likely to be obstructed by at least one streptavidin molecule, since the depth of the pore (40 nm) allows for at least 7 streptavidin molecules in the vertical direction. Indeed, the fact the magnitude of the experimental response fits well with what is expected from geometrical considerations assuming that the streptavidin forms a monolayer, is itself an indication that a sufficiently dense layer of streptavidin has formed on the pore walls.

These results suggest a technique for size estimation of a molecule. The pores 9 in the SiO₂ layer 8 have an average diameter of <d> and a total fractional area surface coverage of F, characterizing the chip 11. The functionalization of the pores 9 with probe molecules reduces the mean diameter to <d−p>=<dₒ>, and target/probe interaction reduces the value of <dₒ> to <dₒ−t>=<d₁>, where p and t are twice the size of probe molecule and target molecule respectively. The average area reduction is related to the square of the average diameters. Reduction in area means a corresponding reduction in conductance (which is inversely related to resistance). Reducing the value of <dₒ> (the pores with probe molecules) to <d₁> reduces the electrical conductance of the chip, i.e. increases the electrical resistance of the pixel, in the ratio (<dₒ>/<d₁>)²=R₁/Rₒ. The size of the target molecule can thus be estimated from a knowledge of <d₀> and the relative increase in resistance of the cell (or, equivalently, the relative decrease in peak oxidisation current during c.v).

The following theoretical considerations are believed to underline this measurement. The electrolyte contains a redox couple e.g. potassium ferricyanide and potassium ferrocyanide (Fe³⁺/Fe⁴⁺), the potential of the electrode is thought to be determined by the ratio of Fe³⁺/Fe⁴⁺, i.e. it behaves in a Nernstian manner. When the voltage is applied as a linear sweep between the electrodes a current passes: the composition of Fe³⁺/Fe⁴⁺ in front of the electrode follows the Nernst equation [E=E°+(RT/nF)(ₛcₒₓ/^{s}c_{red})] and the maximum oxidisation current (see FIG. 4), for a single electron transfer, is given by: Iₘₐₓ=2.69×10⁵ _{red}D^{0.5 o}c_{red} v^{0.5} A, with the current moving units of amps/sq cm; _{red}D the diffusion coefficient of the Fe³⁺ having units of cm² per second; the initial concentration in mole per cc of Fe³⁺ being ^{o}c_{red}; and the linear sweep rate for the voltage being v, with units of volts per second; finally A is the fractional area of electrode structure that is exposed platinum (i.e. the fractional pore area). The same applies to the reduction process. Thus a process of cyclic voltammetry can be used to measure peak current thought to be representative (according to the above theoretical considerations) of the total exposed area, A, of platinum at the bottom of the pores with their probe covered side walls. When the probes are attached to target molecules the area of Pt exposed is reduced and so is A, and so a smaller current flows at the same peak voltage. In some embodiments, the actual quantity measured is thus the peak current on the oxidation (or reduction) curve, before and after exposure to the target material. Other electrochemical ways of measuring the exposed area of Pt are equally envisaged.

It should be noted that <d> and p and t are characteristic of a given chip and probe/target system which can be measured (for example using image processing of an electron micrograph) or estimated, for example from knowledge of the pore distribution and probe molecule geometry.

With reference to FIG. 8, a system for detecting the binding of a target molecule to a probe molecule supported on a probe support member as described above is now described. An electrochemical cell, as described above with reference to FIG. 2, is operatively connected to driving and measurement circuitry 42, for example a computer controlled potentiostat/galvanostat as discussed above. The driving and measurement circuitry 42 is operatively connected to a processor 44 which is arranged to detect changes of the current maximum of the oxidation scan or other measures of the current-voltage relationship of the cell as samples to be tested are applied to the electrochemical cell as described in more detail below. The processor 44 may further be arranged to perform size-estimation based on the maximum current measurements, as described in detail above. An output device 48 is operatively connected to the processor 44 to display the results of the analysis and an input device 46 can be used to control the system, for example to set parameters of the cyclic voltammetry, parameters such as the average pore diameter used in size-estimation and any other parameters, such as locations for data storage and so on.

To perform label-free detection, an electrochemical cell including an electrode assembly 11 as described above, functionalized with a probe specific to the target to be detected in the sample is connected to the driving and measurement circuitry and an initial settling in a calibration phase is carried out in some embodiments, if required, as described above for the maximum current to reach a stable level. Entire electrochemical cells comprising a suitably functionalized electrode assembly may be manufactured and provided as one unit or the electrochemical cell may include a connector for connecting a suitably functionalized electrode assembly to driving and measurement circuitry 42, the remaining components of the electrochemical cell forming part of the system. Similarly, the electrode assembly 11 may be pretreated so that no settling in/calibration stage is required.

Following the addition of a sample to the electrochemical cell (either manually or through a suitable automated device such as a pipette robot or a microfluidic device), the current signal is monitored and a change (increase or decrease as the case may be) in the maximum current is detected as representative of the presence of the target.

Optionally, in some embodiments, the magnitude of the change of the maximum current can be analyzed to estimate a size parameter of the target as described above and displayed on the output device 48 or stored or outputted in any other suitable way. The output device 48 may further or alternatively include one or more data storage devices for storing parameters of the system and both raw and analyzed data pertaining to the target detection.

It will be understood that the above description of some embodiments is of specific examples only and not intended to be limiting on the scope of the invention as claimed in the apendent claims. Many alterations, modifications and juxtapositions of the features described above will be apparent to the skilled person and these are intended to be covered.

In particular, it will be understood that the above-described methods, techniques and systems can be used with targets and probes other than the ones described above. Equally, other fabrication processes for manufacturing a probe support as described above can be used, for example ion beam lithography. Similarly, the materials used in the manufacture of the electrode assembly described above can be interchanged for suitable other materials, for example metals other than platinum may be used for the electrodes or insulators other than SiO₂ may be used as insulators.

Any suitable electrochemical cell may be used in conjunction with the above-described system, and in particular, these are not limited to the reference or counter-electrode described above but rather other materials, shapes and configurations may be used. For example, the counter-electrode may be directly applied to the surface of the SiO₂ surface 8 or, on the other hand, the probe support member may be provided separately from both the working and counter-electrode electrically in between these two as long as the current between the two electrodes is arranged to pass through the hole or pores of the support member.

Other techniques for driving the electrochemical cell and measuring a signal representative of target to probe binding may be used, for example, chronopotentiomentry may be used instead of cyclic voltammetry, and similarly, other characteristics of the measured signals can be used, for example the minimum reducing current or another well-defined point of the measured signal. Similarly, voltage rather than current may be measured.

Electrode Arrays

In some embodiments, strip electrodes similar to the electrodes structure described above are arranged in an electrically addressable array to allow the detection of a potentially large number of target materials. It will be understood that the same considerations regarding the geometry of the electrode structure and its functionalization as for the embodiments described above apply with some additional considerations as set out below.

With reference to FIG. 9, an electrically addressable array of electrodes includes a set of elongate column electrodes (C1, C2, C3, C4) in the form of thin film platinum strips 52 typically 100 microns wide and 90 millimeters long with typically an equal spacing between strips. The thin film platinum strips are carried on an upper substrate plate 54, for example a chemically inert insulating material such as glass or silicon coated with insulating silicon dioxide. The array further comprises a set of row electrodes (R1, R2, R3, R4) in the form of thin film platinum strips of typically the same material, dimensions and separations as the row electrodes. As for the electrodes structure 1 of the first embodiment, a probe supporting insulating layer 56 is disposed on the thin film platinum strip 58 of the row electrodes, defining pores through the insulating layer 56 down to the thin film platinum strips 58. The row electrodes are disposed on a lower substrate plate 60 similar to the substrate plate 54. It will be understood that the row and column electrodes can be interchanged (that is the row electrodes being mere platinum strips and the column electrodes comprising the electrode structure 1 described above) and that their horizontal orientation can be exchanged such that the column electrodes may be carried on the lower plate and the row electrodes may be carried on the upper plate.

The pores in the insulating layer 56 are typically 250-350 microns in diameter and disposed in a uniform density but disordered or random array. Typically, the pores have a total area summing to 20% of the area of the electrodes. Naturally, it will be understood that all electrode structures described above can be made in an elongate shape and equally used with the addressable array. The average pore diameter may be varied over the extent of the electrode such that different intersections or pixels of the array (see below) have different respective average diameters to accommodate probes of differing diameters.

A gasket 62 is disposed between the row and column electrodes to define a volume therebetween for containing an electrolyte. The gasket is preferably made of an inert material so as not to interfere with the operation of the array. One of the substrates 54 and 60, for example the upper one, is provided with one or more, for example two, fluidic access ports allowing electrolyte to be circulated through the volume defined by the gasket and/or chemicals such as target materials to be added to the volume.

The row and column electrodes are disposed relative to each other such that they intersect, typically at right angles, to define overlapping regions where one row electrode overlaps a column electrode and vice versa. To address specifically such an overlapping region, the corresponding row and column electrodes (for example C1 and R2 for overlapping region 66) can be addressed by connecting the corresponding electrodes to a voltage source and current sensor to drive and measure an ionic current through the corresponding overlapping region, as for the electrode structure of the first embodiment. As the detection signal is a relative signal detecting a drop in current (see below), no reference electrode is required.

With reference to FIG. 10, a particular circuit for addressing overlapping regions of an electrode array 70, as described above with reference to FIG. 10 is now described. The circuit comprises a plurality of row 72 and column 74 contacts for connecting to corresponding row and column electrodes of the electrode array 70. The contacts are either arranged to form suitable connectors for mating with corresponding connectors on the electrode array 70 or, in embodiments in which the electrode array is provided together with the electronic components, the connections are permanent. The row contacts 72 are addressed by an analogue multiplexer or shift register 78 arranged to connect one or more of the contacts 72 to a digital to analogue converter (DAC) 80 under the control of a row address latch 82. The row address latch 82 is controlled by a micro controller 89 to connect the DAC 80 to one or more of the contacts 72. The DAC 80 is under control of the micro controller 89 to apply a controlled voltage signal to the row electrode connected to the row contact 72 to which it is connected via the multiplexer 78. Communication between the micro controller 89 and the DAC 80 and row address latch 82 is via a databus 86.

The contacts 74 for connecting to column electrodes are connected to transimpedance amplifiers 88 (or any other suitable current to voltage converter), which are connected to an analogue to digital converter (ADC) 90 by a multiplexer 92. The multiplexer 92 is under control of the micro controller 89 via a column address latch 94 and the ADC 90 produces a digital signal representative of the current at the input of the transimpedance amplifiers 88, which is supplied to the micro controller 89 via databus 86 for current measurement. The micro controller is further connected to a user interface, storage device and other peripherals for reading out the array as described below.

Array Functionalization

The intersecting areas or overlapping regions of the electrodes where the electrodes overlap will be referred to here as “pixels”. The same considerations apply regarding functionalization of the electrodes structure of the pixels as for the single cell of the first embodiment described above. The inner wall of the pores in a particular pixel are coated with a layer (usually less dense than a packed monolayer) of “probe” material which is selected to be a specific probe for a specific target material. This specific probe material over a particular pixel is referred to as “functionalization”. The probe material is attached to the pixel walls via suitable chemistry so that the probe is not liable to desorb from the walls, before, during, or after exposure to electrolyte and test material. The object of the functionalization is to capture the target material (in the sample) to which it is chemically specific, adding it to the thickness of the probe material, thereby reducing the effective diameter of the well. A reduction in the effective diameter of the well results in an increase in the electrical resistance of the column of electrolyte in the well for purely geometrical reasons. An example is the biotin (probe)/streptavidin (target) pair. Probe arrays of a very wide range of chemicals for a wide selection of target materials are envisaged (see e.g. P. Cutler. Proteomics, vol 3, 2003, 2-18 or Zhu et al, Current Opinion in Chemical Biology, vol 5, 2001, 40-45, both herewith incorporated herein by reference). The requirements apart from specificity are, chemical stability, and a resulting dimensional change of effective well diameter that can be measured. Typically the change in diameter should be more than 5%, preferably 20-30%, but not so much as to fill the entire well. Based on these considerations, parameters of the electrode structure, such as average well diameter, and functionalisation, such as probe concentration, can readily be tuned for a given application.

In order to functionalize individual pixels, the following protocol can be adopted. First, a probe material forming pH sensitive bonds with the porous insulating layer 56 is applied to the array such that all overlapping regions are functionalized with this probe material. Then, a voltage is applied to electrode pairs corresponding to all but the pixel or pixels which are to be functionalized with this probe material to break the pH dependent bonds, followed by the area being rinsed to remove any unbound probe material. This leaves only the desired pixels functionalized with this first probe material. Subsequently a second probe material is applied to the array which will functionalize all pixels other than the ones already functionalized (due to competition for binding space). Once the remaining pixels have been functionalized in this way, the pH of those pixels which are not to be functionalized with either the first and second probe material are activated to change the local pH such that the bonds of the second probe material at pixels not to be functionalized by the first and second probe material is broken. After the array has been suitably rinsed, the procedure can again be repeated for a third and subsequent probe material until all pixels or groups of pixels have been functionalized with a corresponding probe material. An example of a suitable probe material is a biotin/streptavidin compound for binding to the insulating substrate with suitable target specific molecules such as antibodies bound to the streptavidin.

Array Electrical Measurement

As for the first embodiment an equi-molar (0.01M) solution of potassium ferricyanide [K₃(Fe(CN)₆] and potassium ferrocyanide [K₄(Fe(CN)₆] in supporting electrolyte of phosphate buffered saline solution (pH 7.4; 0.01M phosphate) is used in some embodiments. With stationary fluid an electrical property, such as resistance, of each pixel is measured and recorded as a reference scan. The reference scan may include an initial stabilization period as described above. The target material is then added to the electrolyte; the material is circulated over the array of probes for a sufficient time (typically a few minutes) for specific attachment to take place. The fluid flow is stopped and the array is now re-measured as a target scan.

The pixel where the probe-target interaction has taken place is revealed by an increase in the resistance of that particular pixel from the reference to target scan, as for the first embodiment. The electrical resistance is measured using cyclic voltammetry as above, which is the application of a linear time ramp in applied cell voltage across a row and a column electrode, giving rise to an associated current (oxidation/reduction of the Fe³⁺/Fe⁴⁺ couple).

In regular cyclic voltammetry, the current peak arises from the fact that the exponential increase of the consumption (see C. H. Hamann, A Hamnett, W. Vielstich, “Electrochemistry”, Wiley-VCH, Weinheim/New York, 1998 pp 222-249, herewith incorporated by reference herein) of the active species at the particular electrode in the cycle during the voltage sweep quickly leads to depletion of the active species near the electrode. The ion flow thus becomes diffusion-limited as the active species now has to diffuse into the pixel volume in the overlapping region between the electrodes from the bulk solution. This process occurs both at the working electrode (WE) and the counter electrode (CE) but with different species of ions (reduced or oxidised). However, if the WE and CE are located closely together (about 100 μm so that the entire electrolyte between the two electrodes is a stationary diffusion layer) the generated species of one ion can directly diffuse over to the other electrode to be collected there and feed the opposite reaction at that electrode. This is the basis for the generation-collection device concept (T. R. L. C. Paixão, E. M. Richter, J. G. A. Brito-Neto and M. Bertotti “Fabrication of a new generator-collector electrochemical micro-device: Characterization and applications”, Electrochem. Commun. 8 (2006) 9-14; L. B. Anderson, C. N. Reilley, “Thin-layer electrochemistry: Use of twin working electrodes for the study of chemical kinetics”, J. Electroanal. Chem. 10 (1965) 538; L. B. Anderson, B. McDuffie, C. N. Reilley, “Diagnostic criteria for the study of chemical and physical processes by twin-electrode thin-layer electrochemistry”, J. Electroanal. Chem. 12 (1966) 477; S. J. Konopka, B. McDuffie, “Diffusion coefficients of ferri- and ferrocyanide ions in aqueous media, using twin-electrode thin-layer electrochemistry”, Anal. Chem. 42 (1970) 1741, all herewith incorporated by reference herein), and instead of a voltammogram peak, this gives rise to an S-shaped voltammogram, since for large potentials across the electrodes, the reaction at each electrode is virtually instantaneous, and the current is only limited by the time it takes for a particular ion species to diffuse across the electrode gap.

Thus the current will increase with increasing potential until it reaches a constant level (total diffusion control) which will be maintained at higher potentials. This steady-state diffusion situation prevails with a linear concentration gradient [T. R. L. C. Paixão, E. M. Richter, J. G. A. Brito-Neto and M. Bertotti “Fabrication of a new generator-collector electrochemical micro-device: Characterization and applications”, Electrochem. Commun. 8 (2006) 9-14) and in a similar manner to the regular cyclic voltammetry peak current (C. H. Hamann, A Hamnett, W. Vielstich, “Electrochemistry”, Wiley-VCH, Weinheim/New York, 1998 pp 222-249). The maximum current is proportional to the projected electrode area (S. J. Konopka, B. McDuffie, “Diffusion coefficients of ferri- and ferrocyanide ions in aqueous media, using twin-electrode thin-layer electrochemistry”, Anal. Chem. 42 (1970) 1741.).

If now a single intersection of the sets of electrodes is considered, the situation is slightly different, since there is both a portion in the intersection where the electrodes are located closely in the overlapping region and portions of the electrodes that are located far from each other elsewhere. If the potential, E, across these electrodes is now scanned from E=0 V, there will initially be a current contribution from all areas of the electrodes since there are ions of both species (reduced or oxidised) present at each electrode. At a certain point, the diffusion limit will be achieved, and there will be a peak in the voltammogram, similar to regular cyclic voltammetry. However, if the scan is continued, as E increases, the electrolyte not in the electrode intersection will be depleted, of the needed species or the needed species is excluded by ohmic drop (an effect enhanced by the thin layer of electrolyte). During the whole scan, the redox reaction in the electrode intersection is constantly fed by direct diffusion through the electrolyte between the two electrodes. At higher E, this current will dominate, and the measured current response (I_{R} in FIG. 11) will only originate from the intersection. This is the desired situation since it allows for discrimination of several functionalized areas along the same line of nanopores. Defining a pixel as the intersection of the top and bottom electrode, this current can thus be used as a measure of the pixel pore area (instead of the peak current as used for single cell embodiments).

As long as the opposed electrodes of a pixel are close enough together to establish an ionic diffusion controlled environment, the pixel operates in the generation-recombination mode of cyclic voltammetry. This configuration and mode of operation prevents the formation of spurious electrical paths via other electrodes at levels of E where the current substantially saturates. Using this saturated current as a measure keeps the current measurement substantially exclusive to the particular pixel.

Thus, at higher voltages the current saturates, (I_{R}), and is characteristic of the pixel resistance, i.e. a flattened S-shaped curve is obtained: see FIG. 11 showing I_{R} for the reduction current. A corresponding oxidation current can equally be used. I_{R} can be measured by any current measurement where the current response to the applied voltage has saturated, for example at a predetermined voltage in the applied voltage profile.

Array Readout

The array can be addressed a-pixel-at-a-time by connecting the rows to the columns in sequence while the unconnected lines are floating. Thus the row shift register 78 might connect row R2 (that means rows R1, R3 etc are floating) to column C3 via the column shift register 92 (that means columns C1, C2 etc are floating). In this case pixel [R2, C3] is connected while all other lines are floating. Here the measurement time per pixel is the cycle time. Typical cv cycle time is 5-30 seconds.

An array can also be addressed a row-at-a-time for more rapid read-out. Here a row is connected and voltage is ramped up in accordance with V(t) and then held at V(max) giving a cycle times of T. While the row and all its intersecting columns are at V(max) the current in each column is measured, giving the individual pixel currents. The total measurement time per pixel is the time to measure the individual column current, typically <1 second plus the cycle time divided by the number of pixels per row. The total time per row with N columns is then current measurement time, Nt (e.g. t=0.1 sec), plus cycle time T (e.g. 10 sec). This gives [Nt+T] sec. per line i.e. [Nt+T]/N seconds per pixel. So a 20×20 array might take 240 seconds for a single scan or about 480 seconds for both the reference and target scan, that is about 8 minutes.

Exemplary use of an Array

In some embodiments, a fully functionalized electrode array is provided complete with electrolyte and an external pump line in an antiseptic package. For use, the package is opened and clipped into a small electronic device having a mechanical holder for holding the package and making contact with the array as set out above. The device includes the circuitry described with reference to FIG. 10 and may be not much bigger than a mobile phone. It also includes a peristaltic pump with connectors for connecting to the ports 64 to allow circulation of the electrolyte and sample injection and a sample injector for injecting a quantity of sample material. Once the antiseptic package is connected to the device, the pump is started to ensure uniform electrolyte concentration and then stopped to allow measurements of pixel currents (resistances) to be obtained as a baseline reading or reference scan, for example using row at a time scanning as described above. When scanning is complete, the micro processor is programmed to alert the user that the device is ready to receive a sample or sample injection may be started automatically. The sample is then injected into the array and the electrolyte is circulated to distribute the sample throughout the array. The pump is then stopped and the array is scanned, again for example using line at a time scanning and the current values for each pixel are stored. Comparing the current stored for each pixel to the respective stored base line currents, pixels at which target molecules are bound are detected by the micro processor as pixels where there has been a drop in current, indicating that target material is bound to the pixel in question. From a knowledge of the probe material present at each pixel, the micro controller then outputs an indication identifying any target material found to be present via the user interface 96. To this end, the device may include a reader for reading a computer readable medium, for example a two dimensional bar code on the antiseptic package to read the identity of the probe material at each pixel. Alternatively, the reader may read a coded label, with the micro controller looking up the pixel probe material configuration in a local table accessed using the information of the coded label.

In some embodiments, the antiseptic package and electrode array may be disposable after each use or, in others, the electrode array may be reusable after suitable washing of the array.

It will be understood that the above description of specific embodiments of the invention is by way of example only and not intended to limit the scope of the invention as claimed in the appendent independent claims.

1. A system for detecting a target binding to a probe, the system comprising:
an electrochemical cell for containing an electrolyte, driving circuitry for driving a current through the cell, and a porous probe supporting member functionalized with probes which is arranged within the electrochemical cell such that the current passes through the pore or pores of the probe supporting member; the system further comprising:
measuring circuitry for measuring a quantity representative of a cross-sectional area of the pore or pores and a processor for detecting a change in the quantity as representative of target to probe binding, in which the processor is arranged to estimate an effective size of a target for the probe as a function of a fractional change in the quantity.

2. A system as claimed in claim 1 wherein the probe supporting member defines a hole therethrough which defines an effective cross-section through which, in an electrolyte, a current can flow between two electrodes; wherein a probe is disposed on the member in relation to the hole such that the effective cross-section is changed on binding of a target to the probe, thereby enabling the binding to be detected by a corresponding change in the current.

3. A system as claimed in claim 2 including an electrode structure, the electrode structure including a conducting electrode layer having a first face secured to the probe supporting member.

4. A system as claimed in claim 1 in which the driving circuitry is arranged for cyclic voltammetry.

5. A system as claimed in claim 4 in which the measuring circuitry is arranged to measure the current at a predetermined point in the voltammetry cycle as the quantity.

6. A system as claimed in claim 1 in which the processor is arranged to estimate the effective size as a function of an average diameter d of the pore or pores.

7. An addressable electrode array comprising:
a first set of elongate electrodes and a second set of elongate electrodes disposed in relation to the first set of electrodes to define a plurality of overlapping regions for each electrode where respective electrodes of each set overlap; the array including at least one probe supporting member, the probe supporting member defining a hole therethrough which defines an effective cross-section through which, in an electrolyte, a current can flow between two electrodes; wherein a probe is disposed on the member in relation to the hole such that the effective cross-section is changed on binding of a target to the probe, thereby enabling the binding to be detected by a corresponding change in the current, the member disposed between respective electrodes of the first and second set such that there is at least one hole in each overlapping region.

8. An electrode array as claimed in claim 7 in which the distance between the first and second sets of electrode is smaller than a width of the elongated electrodes.

9. An electrode array as claimed claim 7 in which each set of electrodes is disposed on a respective support plate.

10. An electrode array as claimed in claim 9 in which a gasket is disposed between the respective support plates to space the plates from each other and define a volume for accepting an electrolyte in between the plates.

11. An electrode array as claimed in claim 10 in which at least one of the plates defines at least one fluidic communication port in fluidic communication with the volume.

12. An electrode array as claimed in claim 7 in which the electrodes of the first set are functionalized in the overlapping regions with respective probe materials specifically binding corresponding ones of a plurality of substances.

13. An electrode array as claimed in claim 12 further comprising a voltage source configured to electrically address individual overlapping regions to test for the presence of one or more substances corresponding to the respective probe materials in respective overlapping regions.

14. An electrode array as claimed in claim 13, wherein the voltage source is configured to apply a voltage to one electrode from each set to produce a diffusion limited ionic current in an overlapping region where said two electrodes overlap, thereby measuring an ionic current specific to the overlapping regions.

15. An electrode array as claimed in claim 14, configured to ramp up a voltage applied to said electrodes in accordance with a profile, monitoring a resulting current and measuring a value of current as representative of a current from the overlapping region at a time after the current has reached a saturation level.

16. A method of reading an electrically addressable array as claimed in claim 7 including applying a voltage to one electrode from each set to produce a diffusion limited ionic current in an overlapping region where said two electrodes overlap, thereby measuring an ionic current specific to the overlapping regions.

17. A method as claimed in claim 16 including ramping up a voltage applied to said electrodes in accordance with a profile, monitoring a resulting current and measuring a value of current as representative of a current from the overlapping region at a time after the current has reached a saturation level.

18. A method of functionalizing electrically addressable regions of an addressable array with different respective probe materials specific to corresponding substances, the method comprising: (a) designating one or more addressable regions to be functionalized with a probe material; (b) applying the probe material to the array to bind to the array using a pH dependent bond; (c) electrically altering the pH in all but the designated addressable region or regions to locally break pH dependent bonds; (d) designating one or more further addressable regions to be functionalized with a further probe material; (e) applying the further probe material to the array to bind to the array using a pH dependent bond; (f) electrically altering the pH in all but the previously functionalized and further addressable regions to locally break pH dependent bonds; and (g) repeating steps (d) to (f) for subsequent probe materials as often as required.

19. A method as claimed in claim 18 in which the probe materials include a biotin-streptavidin compound with a probe molecule specifically binding a respective substance bound to the streptavidin.

20. A method as claimed in claim 18 in which the electrically addressable regions are defined by corresponding intersections of a first set of elongate electrodes with a second set of elongate electrodes and electrically altering the pH in an addressable region includes applying a voltage between a pair of electrodes, one from each set, corresponding to the addressable region.
